(19) United States
(12) Patent Application Publication
(10) Pub. No.: US 2025/0269349 A1
(43) Pub. Date: Aug. 28, 2025

(54) AERODYNAMIC SPACERS

(71) Applicant: Donaldson Company, Inc., Bloomington, MN (US)

(72) Inventors: Shane Lawson, Waconia, MN (US); Christopher P. Conklin, Columbia, MD (US); Benjamin C. Druecke, Hudson, WI (US); Alexander E. Mottet, Minneapolis, MN (US); Kristof Decoster, Vilvoorde (BE); Yehya A. Elsayed, Bloomington, MN (US); Abhishek Maharia, Badnoli (IN); Rohit Singh, Gurugram (IN); Elena T. Ewaldz, Minneapolis, MN (US); Laurent Coustenoble, Bailleulval (FR)

(21) Appl. No.: 19/058,774

(22) Filed: Feb. 20, 2025

Related U.S. Application Data
(60) Provisional application No. 63/556,658, filed on Feb. 22, 2024.

(51) Int. Cl. B01J 19/30

(52) U.S. Cl. CPC B01J 19/305; B01J 2219/30491

(57) ABSTRACT

A spacer array including a plurality of spacers. Each spacer defines a longitudinal axis and includes a main body, a leading pin, and a trailing pin. The main body has a main body cross-sectional dimension. The leading pin extends from the main body and is upstream of the main body. The leading pin has a leading pin cross-sectional dimension. The trailing pin extends from the main body and is downstream of the main body. The trailing pin has a trailing pin cross-sectional dimension. The main body cross-sectional dimension is greater than the leading pin cross-sectional dimension and the trailing pin cross-sectional dimension.

### CROSS-REFERENCE TO RELATED APPLICATION

This application claims the benefit of U.S. Provisional Application 63/556,658 filed on Feb. 22, 2024, the subject matter of which is incorporated by reference in its entirety.

### FIELD

The present disclosure relates to spacers, and more specifically, to cassette spacers. The present disclosure further relates to methods of making spacers.

### SUMMARY

Embodiments herein may describe a spacer, a spacer array, a packed bed, and methods of making the same. In one embodiment, a spacer array may include a plurality of spacers. Each spacer may define a longitudinal axis and include: a main body, a leading pin, and a trailing pin. The main body may have a main body cross-sectional dimension. The leading pin may extend from the main body and upstream of the main body. The leading pin may have a leading pin cross-sectional dimension. The trailing pin may extend from the main body and downstream of the main body. The trailing pin may have a trailing pin cross-sectional dimension. The main body cross-sectional dimension may be greater than the leading pin cross-sectional dimension and the trailing pin cross-sectional dimension.

In one embodiment, a packed bed may include a spacer array. The spacer array may include a plurality of spacers. Each spacer may define a longitudinal axis and include: a main body, a leading pin, and a trailing pin. The leading pin may extend from the main body and upstream of the main body. The trailing pin may extend from the main body and downstream of the main body. The main body may have a main body cross-sectional dimension greater than a leading pin cross-sectional dimension and a trailing pin cross-sectional dimension. The spacer array may further include a packing material disposed between the plurality of spacers.

In one embodiment, a method of making a spacer array may include molding or printing a plurality of spacers. Each spacer may define a longitudinal axis and include: a main body, a leading pin, and a trailing pin. The leading pin may extend from the main body and upstream of the main body. The trailing pin may extend from the main body and downstream of the main body. The main body may have a main body cross-sectional dimension greater than a leading pin cross-sectional dimension and a trailing pin cross-sectional dimension. The method may further include assembling the spacer array containing the plurality of spacers.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF FIGURES

FIG. 1 is a schematic side view diagram illustrating a spacer in accordance with certain embodiments.

FIG. 2 is a schematic top view diagram illustrating the spacer of FIG. 1.

FIG. 3 is a schematic side view diagram illustrating a spacer in accordance with certain embodiments.

FIG. 4 is a schematic perspective view of the spacer of FIG. 3.

FIG. 5 is a schematic top view of the spacer of FIG. 3.

FIG. 6 is a schematic bottom view of the spacer of FIG. 3.

FIG. 7 is a side view of a spacer in accordance with certain embodiments.

FIG. 8 is a top view of the spacer of FIG. 7.

FIG. 9 is a schematic side view diagram illustrating another spacer in accordance with certain embodiments.

FIG. 10 is a schematic top view diagram illustrating the spacer of FIG. 9.

FIG. 11 is a schematic side view diagram illustrating a spacer in accordance with certain embodiments.

FIG. 12 is a schematic perspective view of the spacer of FIG. 11.

FIG. 13 is a schematic top view of the spacer of FIG. 11.

FIG. 14 is a schematic bottom view of the spacer of FIG. 11.

FIG. 15 is a perspective view of a spacer grid, in accordance with certain embodiments.

FIG. 16 is a perspective view of a spacer array, in accordance with certain embodiments.

FIG. 17 is a side view of the spacer array of FIG. 16.

FIG. 18 is a cross-sectional view of the spacer array of FIG. 17.

FIG. 19 is a top view of the spacer array of FIG. 16.

FIG. 20 is a diagrammatic side view of a filter in accordance with certain embodiments;

FIG. 21 is an example method of making a spacer array in accordance with certain embodiments.

FIG. 22 is an example method of flowing fluid through a spacer array in accordance with certain embodiments.

FIG. 23A is a simulated diagrammatic perspective view of fluid flow through a spacer array in accordance with certain embodiments.

FIG. 23B is a simulated diagrammatic side view of the fluid flow through the spacer array of FIG. 23A.

FIG. 24A is a simulated graph comparison of various cross-sectional spacer shapes vs. restriction.

FIG. 24B is a simulated graph comparison of the various cross-sectional spacer shapes vs. initial toluene removal.

FIG. 25A is a simulated flow profile of a spacer array, in accordance with certain embodiments.

FIG. 25B is a simulated flow profile of a spacer array, in accordance with certain embodiments.

FIG. 25C is a simulated flow profile of a spacer array, in accordance with certain embodiments.

FIG. 26 is a simulated contaminant profile of a spacer array, in accordance with certain embodiments.

FIG. 27 is a simulated graph comparison of pressure drop and adsorption efficiency vs. number of spacers.

FIG. 28A is a simulated contaminant profile using parallel spacers.

FIG. 28B is a simulated contaminant profile using offset spacers.

FIG. 29A is a simulated pressure profile using parallel spacers.

FIG. 29B is a simulated pressure profile using offset spacers.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### Definitions

All scientific and technical terms used herein have meanings commonly used in the art unless otherwise specified. The definitions provided herein are to facilitate understanding of certain terms used frequently herein and are not meant to limit the scope of the present disclosure.

The term “polymer” and “polymeric material” include, but are not limited to homopolymers, copolymers, blends of two or more homopolymers, blends of two or more copolymers, blends of one or more homopolymers and one or more copolymers that have any geometric configuration such as a linear configuration, branched configuration, graft configuration, star configuration, isotactic symmetry, syndiotactic symmetry, atactic symmetry, or any combination thereof. Copolymers are polymers polymerized from two or more monomers and include block copolymers, alternating copolymers, periodic copolymers, statistical copolymers, stereoblock copolymers, gradient copolymers, and the like. Polymers are polymerized from one or more monomers. A polymer polymerized from a particular monomer may be described as “monomer name” polymer or poly(monomer name). For example, a polymer polymerized from n-butyl acrylate monomers, may be described as an n-butyl acrylate polymer or poly(n-butyl acrylate).

The term “longitudinal direction” is used herein to describe the direction along a longitudinal axis, x, as described further herein. The term “axial direction” is used herein to describe a direction perpendicular to the longitudinal axis x.

The terms “upstream” and “downstream” are used herein to describe respective positions within a fluid flow (e.g., an airflow). For example, if body A is upstream of body B, then the airflow will encounter A before B. In such an example, body B would be downstream of body A. Further, although the term “airflow” may be used throughout, it is understood that this disclosure applied not only to airflow, but also to fluid flow.

The term “substantially” as used here has the same meaning as “significantly,” and can be understood to modify the term that follows by at least about 90%, at least about 95%, or at least about 98%.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

In this description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

In several places throughout the following description, guidance is provided through lists of examples, which examples can be used in various combinations. In each instance, the recited list serves only as a representative group and should not be interpreted as an exclusive list.

### DETAILED DESCRIPTION

The present disclosure relates to spacers for use with packed beds. The packed bed may be, for example, a packed bed filter. The packed bed may be, for example, a packed bed reactor. The packed beds containing the spacers may be used for any fluid (i.e., gas or liquid) application. The present disclosure further relates to methods of making spacers for use with packed beds. A packed bed is a housing packed with a packing material designed to for a specific application. Packing material may include filtration material. Packing material may include catalytic material. A packed bed may be subjected to a continuous flow of a fluid. A packed bed may be subjected to intermittent flow of a fluid.

In many cases, it may be desirable to provide a packed bed filter with the capability to filter, remove, or at least partially remove, contaminants from a fluid. Additionally, it may be desirable to provide a packed bed reactor with the capability of catalyzing one or more chemical transformations. In some cases, a packed bed filter may also be a packed bed reactor, or a packed bed reactor may also be a packed bed filter. For example, a packed bed filter/reactor may be packed with catalytic material capable of transforming a contaminant compound from a fluid flow into another compound thereby removing the contaminant compound.

It may be desirable to provide a packing material for removing contaminants from fluid. Packed bed filters and/or reactors such as those described herein may be used to filter air in fuel cell systems. In fuel cell systems, filtration efficiencies below 1 part per billion (ppb) may be desirable to prevent loss of performance of the fuel cell system. The higher flow of fuel cell air intake systems (ranging from around 3 to around 24 cubic meters per minute) can make it difficult to achieve such high filtration efficiencies.

In many instances, filter efficiency is increased by increasing fluid flow restriction, especially at high flow rates. However, increasing restriction results in higher pressure drops and/or slower filtration due to the more tortuous flow paths. In some cases, higher pressure drops can harm the filter itself. Packed bed filters may provide improved filtration performance (compared to, e.g., pleated filters) due to better flow uniformity and higher surface area, while also retaining a low fluid flow restriction. Lower restriction allows more air to be filtered over the same period of time as a filter with higher flow restriction. Packed bed filters may be described as having a volume of filtration material (e.g., a foam), which may be interspersed with spacers.

Spacers may provide structure to a filtration material (i.e., a packing material) in a packed bed filter, which may advantageously allow for higher fluid flow rates through the filter without harming the filtration material. Spacers may also provide increased filtration efficiency if the spacer itself is constructed of or with filtration material. Spacers may also be used to guide fluid flow to induce a more desirable fluid flow pattern (e.g., turbulent fluid flow), resulting in increased filtration efficiency as the fluid impinges upon a larger surface area of filter material.

Similarly, regarding packed bed reactors packed with a catalytic material (i.e., a packing material), spacers may provide structure to a catalytic material in a packed bed reactor, which may advantageously allow for higher fluid flow rates through the reactor without harming the catalytic material. Spacers may also provide increased catalytic turnover if the spacer itself is constructed of or coated with catalytic material. Spacers may also be used to guide fluid flow to induce a more desirable fluid flow pattern (e.g., turbulent fluid flow), resulting in increased catalytic turnover as the fluid impinges upon a larger surface area of catalytic material.

A packed bed may be packed with any suitable packing material. For example, a packing material may include a filter material. Further, for example, a packing material may inlude a catalytic material. Materials within the packed bed may include a foam (e.g., reticulated foam as described further herein). Packing material may be formed in any 3D shape or structure while simultaneously allowing fluid flow through the entirety of the packing material. Packing material may advantageously induce generally uniform fluid flow throughout the packed bed. The number of pores per inch (PPI) within the packing material and the dimensions of the packing material can affect the fluid flow through the packing material and the filtration efficiency of the filter material.

The shape and distribution of spacers within the packing material may be varied in order to provide efficient and effective filtration through the packed bed without increasing restriction of fluid flow or pressure drop through the packed bed. The shape and distribution of spacers within the packing material may be varied in order to provide efficient and effective catalysis through the packed bed without increasing restriction of fluid flow or pressure drop through the packed bed.

It would be desirable to provide aerodynamic spacers that provide efficient and effective filtration without unduly increasing restriction of fluid flow. It would be desirable to provide aerodynamic spacers that provide efficient and effective catalysis without unduly increasing restriction of fluid flow.

It would be desirable to provide a spacer array with aerodynamic spacers that provides efficient and effective filtration without unduly increasing restriction of fluid flow. It would be desirable to provide a spacer array with aerodynamic spacers that provides efficient and effective catalysis without unduly increasing restriction of fluid flow.

It would be desirable to provide a filter containing aerodynamic spacers that provides efficient and effective filtration without unduly increasing restriction of fluid flow. It would be desirable to provide a filter containing aerodynamic spacers that provides efficient and effective catalysis without unduly increasing restriction of fluid flow.

It would be desirable to provide a filter containing a spacer array with aerodynamic spacers that provides efficient and effective filtration without unduly increasing restriction of fluid flow. It would be desirable to provide a filter containing a spacer array with aerodynamic spacers that provides efficient and effective catalysis without unduly increasing restriction of fluid flow.

The present disclosure provides aerodynamic spacers. The aerodynamic spacers provide efficient and effective filtration without unduly increasing restriction of fluid flow. The aerodynamic spacers provide efficient and effective catalysis without unduly increasing restriction of fluid flow.

The present disclosure provides a spacer array with aerodynamic spacers. The spacer array with aerodynamic spacers provides efficient and effective filtration without unduly increasing restriction of fluid flow. The spacer array with aerodynamic spacers provides efficient and effective catalysis without unduly increasing restriction of fluid flow.

The present disclosure provides a packed bed containing aerodynamic spacers. The packed bed containing aerodynamic spacers provides efficient and effective filtration without unduly increasing restriction of fluid flow. The packed bed containing aerodynamic spacers provides efficient and effective catalysis without unduly increasing restriction of fluid flow.

The present disclosure provides a packed bed containing aerodynamic spacers. The packed bed containing aerodynamic spacers provides efficient and effective filtration without unduly increasing restriction of fluid flow. The packed bed containing aerodynamic spacers provides efficient and effective catalysis without unduly increasing restriction of fluid flow.

Aerodynamic Spacers, and Spacer Arrays with Aerodynamic Spacers

According to an embodiment, spacers of the present application can be shaped to be aerodynamic. An aerodynamic shape is one that reduces drag from fluid moving past the shape, compared to a shape that is otherwise similar but is not aerodynamic. Aerodynamic spacers thus reduce drag from fluid moving past, along, and/or around the spacers. Aerodynamic spacers may advantageously provide structure to a packed bed, and may further advantageously increase filtration efficiency. Aerodynamic spacers may advantageously provide structure to a packed bed, and may further advantageously increase catalysis efficiency. Aerodynamic spacers may further advantageously induce a more desirable fluid flow along/around the spacer and through the packed bed, and may further advantageously resist increasing restriction of fluid flow along/around the spacer and through the packed bed. The spacers may be grouped together to form a spacer array. The spacers or spacer arrays may be used in packed beds such as packed bed filters and/or packed bed reactors.

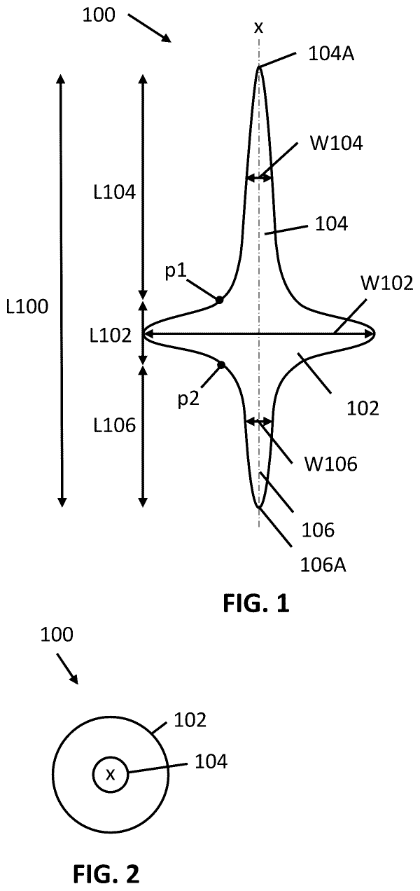

FIGS. 1-2 illustrate an example spacer that may be used in a packed bed. The spacer may have any suitable shape, structure, and size, and may be constructed of any suitable material, as further discussed below. In some embodiments, there may be a plurality of spacers that together form a spacer array that may be used in a packed bed. FIG. 1 is a schematic side view diagram illustrating a spacer 100. FIG. 2 is a schematic top view diagram illustrating the spacer 100. As illustrated in FIG. 1, the spacer 100 defines a longitudinal axis, x, extending along a centerline of the spacer 100. The longitudinal axis, x, may or may not be aligned with a longitudinal axis of a packed bed, a filter, a filter array, or a longitudinal axis of a foam. That is, the spacer 100 may be longitudinally aligned with other objects, or may be misaligned from other objects, as discussed further herein.

The spacer 100 includes a main body 102. The main body 102 has a cross-sectional dimension W102. The main body cross-sectional dimension W102 may be any cross-sectional measurement of the main body 102 as measured in a plane perpendicular to the longitudinal axis x. The main body cross-sectional dimension W102 may vary along a main body length L102. The main body length L102 may be defined as the maximum dimension of the main body 102. The main body length L102 may be measured along the longitudinal axis x. The main body 102 may be substantially lentil-shaped. That is, the main body 102 may resemble a lentil, or a disc or lens. Such shapes may advantageously create an aerodynamic main body 102. Fluid flow along and/or around the main body 102 may have lower restriction or resistance due to the lentil-shape, at least because fluid flow will not encounter any sharp corners (e.g., vertices or edges) or blockages. An outer surface of the spacer 100 may define a curved surface contour. The outer surface of the spacer 100 may be free of edges and vertices. Spacers 100 with curved surfaces and/or surfaces free of edges and vertices may advantageously reduce fluid flow restriction or resistance, allowing greater and/or faster fluid flow along and/or around the spacer 100.

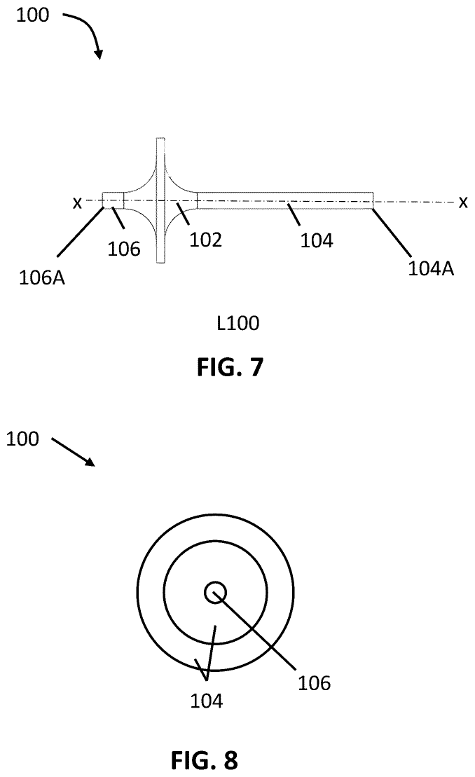

The main body of the spacer may have any suitable length L102. The main body length L102 may be, for example, 2.0 centimeters (cm) or less, 1.5 cm or less, 1.25 cm or less, 1.0 cm or less, or 0.5 cm or less. The main body length L102 may be 0.2 cm or more, 0.5 cm or more, 0.8 cm or more, 1.2 cm or more, 1.8 cm or more, or 2.4 cm or more. The main body length L102 may range from 1.0 cm to 3.0 cm or from 0.5 cm to 2.5 cm. The main body cross-sectional dimension W102 may be, for example, 4.0 cm or less, 3.0 cm or less, 2.0 cm or less, 1.5 cm or less, 1.25 cm or less, 1.0 cm or less, or 0.5 cm or less. The main body cross-sectional dimension W102 may be 0.2 cm or more, 0.8 cm or more, 1.2 cm or more, 1.8 cm or more, 2.4 cm or more, 3.4 cm or more, or 4.4 cm or more. The main body cross-sectional dimension W102 may range from 0.2 cm to 1.0 cm, from 0.5 cm to 2.0 cm, or from 0.5 cm to 3.5 cm. In one embodiment, the main body length L102 may be about 1.5 cm and the main body cross-sectional dimension W102 may be 2.15 cm, as illustrated in FIGS. 7-8.

The spacer 100 may include a leading pin 104. The leading pin 104 may extend from the main body 102 in a longitudinal direction away from the main body 102. The leading pin 104 is considered to be bounded by the main body 102 at a point p1 where a tangent of the surface of the spacer 100, measured in a vertical cross-sectional plane (e.g., as in FIG. 1), crosses 45 degrees relative to the longitudinal axis x. When the spacer 100 is positioned in a fluid flow, the leading pin 104 may be upstream of the main body 102. Thus, airflow along and/or around the spacer 100 will encounter the leading pin 104 before encountering the main body 102. The leading pin 104 defines a leading pin cross-sectional dimension, W104. The leading pin cross-sectional dimension W104 may be any cross-sectional measurement of the leading pin 104 as measured in a plane perpendicular to the longitudinal axis x. The leading pin cross-sectional dimension W104 may vary along a leading pin length, L104. The leading pin length L104 may be defined as the maximum dimension of the leading pin 104 measured along the longitudinal axis x.

A leading pin distal end 104A may come to a point (FIG. 1) or may have a rounded tip or a blunt tip (e.g., as in FIG. 7). A pointed tip may advantageously reduce resistance to fluid flow in the downstream direction. A blunt tip may advantageously provide turbulent or tortuous flow, which may increase the surface area of the spacer 100 that the fluid contacts and may increase the surface area of any surrounding foam that the fluid contacts. Such increased contact(s) may increase the filter efficiency, as more fluid contacts more of the filter material. Additionally, filter efficiency may increase as more fluid contacts the (that may be constructed of or with filter material).

The leading pin length L104 may be, for example, 4.0 cm or less, 2.5 cm or less, 2.0 cm or less, 1.5 cm or less, 1.25 cm or less, 1 cm or less, or 0.5 cm or less. The leading pin length L104 may be 0.2 cm or more, 0.5 cm or more, 0.8 cm or more, 1.2 cm or more, 1.8 cm or more, 2.4 cm or more, or 3.4 cm or more. The leading pin length L104 may range from 1.0 cm to 3 cm, or from 0.5 cm to 2.5 cm. The leading pin cross-sectional dimension W104 may be, for example, 2.0 cm or less, 1.5 cm or less, 1.25 cm or less, 1.0 cm or less, 0.5 cm or less. The leading pin cross-sectional dimension W104 may be 0.2 cm or more, 0.8 cm or more, 1.2 cm or more, 1.8 cm or more, or 2.4 cm or more. The leading pin cross-sectional dimension W104 may range from 0.2 cm to 1.0 cm, or from 0.5 cm to 2.0 cm. In one embodiment, the leading pin length L104 may be about 3.0 cm and the leading pin cross-sectional dimension W104 may be 0.15 cm at a leading pin distal end 104A, as illustrated in FIGS. 7-8.

The spacer 100 may include a trailing pin 106. The trailing pin 106 may extend from the main body 102 in a longitudinal direction away from the main body 102. The trailing pin 106 is considered to be bounded by the main body 102 at a point p2 where a tangent of the surface of the spacer 100, measured in a vertical cross-sectional plane (e.g., as in FIG. 1), crosses 45 degrees. When the spacer 100 is positioned in a fluid flow, the trailing pin 106 may be downstream of the main body 102. Thus, airflow along and/or around the spacer 100 will encounter the main body 102 before encountering the trailing pin 106. The trailing pin 106 defines a trailing pin cross-sectional dimension, W106. The trailing pin cross-sectional dimension W106 may be any cross-sectional measurement of the trailing pin 106 as measured in a plane perpendicular to the longitudinal axis x. The trailing pin cross-sectional dimension W106 may vary along a trailing pin length L106. The trailing pin length L106 may be defined as the maximum dimension of the trailing pin 106 measured along the longitudinal axis x.

A trailing pin distal end 106A may come to a point (FIG. 1) or may have a blunt tip (e.g., as in FIG. 7). A pointed tip may advantageously reduce resistance to fluid flow in the downstream direction. A blunt tip may advantageously provide turbulent or tortuous flow, which may increase the surface area of the spacer 100 that the fluid contacts and may increase the surface area of any surrounding foam that the fluid contacts. Such increased contact(s) may increase the filter efficiency, as more fluid contacts more of the packing material within the packed bed filter itself.

The trailing pin length L106 may be, for example, 3.5 cm or less, 2.5 cm or less, 2.0 cm or less, 1.5 cm or less, 1.25 cm or less, 1 cm or less, or 0.5 cm or less. The trailing pin length L106 may be 0.2 cm or more, 0.8 cm or more, 1.2 cm or more, 1.8 cm or more, 2.4 cm or more, or 3.4 cm or more. The trailing pin length L106 may range from 1 cm to 3 cm or from 0.5 cm to 2.5 cm. The trailing pin cross-sectional dimension W106 may be, for example, 2.5 cm or less, 2.0 cm or less, 1.5 cm or less, 1.25 cm or less, 1.0 cm or less, or 0.5 cm or less. The trailing pin cross-sectional dimension W106 may be 0.2 cm or more, 0.8 cm or more, 1.2 cm or more, 1.8 cm or more, or 2.4 cm or more. The trailing pin cross-sectional dimension W106 may range from 0.2 cm to 1.0 cm or from 0.5 cm to 2.0 cm. In one embodiment, the trailing pin length L106 may be about 0.5 cm and the trailing pin cross-sectional dimension W106 may be 0.15 cm at a trailing pin distal end 106A, as illustrated in FIGS. 7-8.

The spacer 100 defines a spacer length L100, measured along the longitudinal axis x. The spacer length L100 is equal to the total length of the spacer as defined by the addition of the leading pin length L104, the main body length L102 and the trailing pin length L106 all together (FIG. 1). The spacer length L100 may be, for example, 5.0 cm or less, 2.5 cm or less, 2.0 cm or less, 1.5 cm or less, 1.25 cm or less, 1 cm or less, or 0.5 cm or less. The spacer length L100 may be 0.2 cm or more, 0.8 cm or more, 1.2 cm or more, 1.8 cm or more, 2.4 cm or more, 3.4 cm or more, or 4.4 cm or more. The spacer length L100 may range from 1 cm to 3 cm or from 0.5 cm to 2.5 cm. In one embodiment, the spacer length L100 may be about 5.0 cm, as illustrated in FIG. 7.

The leading pin length L104 may be greater than the trailing pin length L106. A longer leading pin 104 may advantageously provide less resistance or restriction to the fluid flow, as the leading pin 104 can more gradually increase the leading pin cross-sectional dimension W104. A more gradual increase in the leading pin cross-sectional dimension W104 provides less resistance or restriction than a faster increase in the leading pin cross-sectional dimension W104, as the fluid flow moves downstream and encounters the increasing leading pin cross-sectional dimension W104. On the downstream side of the main body 102, the fluid flow moves from a higher resistance area created by the main body 102 to a lower resistance area created by the trailing pin 106. Thus, it is less important for the trailing pin 106 to provide a decreasing trailing pin cross-sectional dimension W106 that decreases as gradually as the gradual increase in the leading pin cross-sectional dimension W104, because the fluid flow is encountering less resistance/restriction along the length of the trailing pin 106. In some alternative embodiments, the trailing pin is very short or the spacer 100 may not include a trailing pin at all, which may advantageously save material required for the spacer 100. However, in embodiments with the trailing pin 106, the trailing pin 106 may advantageously re-direct fluid flow in the downstream direction. A ratio of the leading pin length L104 to the trailing pin length L106 may be 1.25 parts or greater to 1 part, 1.01 parts or greater to 1 part, 1.5 parts or greater to 1 part, or 2 parts or greater to 1 part. The ratio of L104 to L106 may be 10 parts or less to 1 part, 5 parts or less to 1 part, or 3 parts or less to 1 part.

As illustrated in FIG. 2, from a top view along the longitudinal axis x of the spacer 100, the leading pin 104 and the main body 102 are visible. As illustrated in FIGS. 1-2, the main body cross-sectional dimension W102 is greater than the leading pin cross-sectional dimension W104. The main body cross-sectional dimension W102 is greater than the trailing pin cross-sectional dimension W106. These relative cross-sectional dimensions may advantageously allow for fluid flow (e.g., air flow) to encounter the leading pin 104 prior to encountering the main body 102. The smaller cross-sectional dimension of the leading pin 104 is less resistive or restrictive to the airflow. Thus, the spacer 100 is more aerodynamic. The fluid flow will encounter the most resistance or restriction at the main body 102. Then, the fluid flow will flow around the main body 102 and along the trailing pin 106. The relative cross-sectional dimensions may advantageously allow for fluid flow to encounter the main body 102 prior to encountering the trailing pin 106. The smaller cross-sectional dimension of the trailing pin 106 is less resistive or restrictive to the fluid flow. Thus, the fluid flow will be directed along the trailing pin 106 to continue through the packed bed with minimal resistance or restriction.

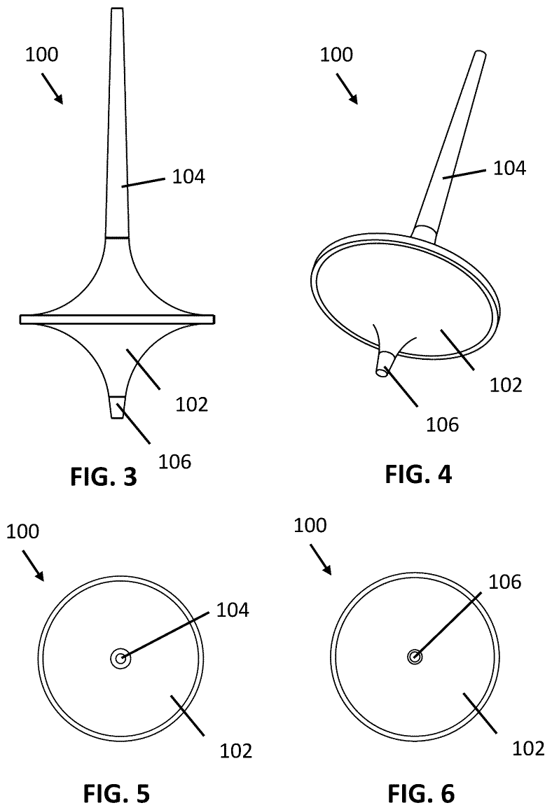

FIGS. 3-6 provide further illustrations of the spacer 100. FIGS. 3-4 illustrate the spacer 100, including the main body 102, the leading pin 104, and the trailing pin 106 as described herein. FIG. 5 illustrates a top-down view of the spacer 100, and thus only the leading pin 104 and the main body 102 are visible. FIG. 6 illustrates a bottom-up view of the spacer 100, and thus only the trailing pin 106 and the main body 102 are visible.

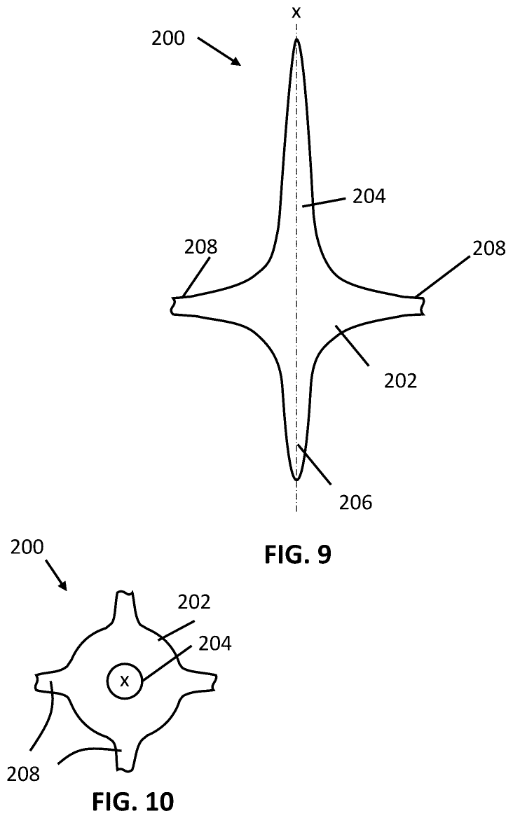

FIGS. 9-10 illustrate a cut-away view of a connected spacer 200 that may be used in a packed bed (e.g., a filter). The spacer 200 may have any suitable shape, structure, and size, and may be constructed of any suitable material, as further discussed below. In some embodiments, there may be a plurality of connected spacers 200 that together form a spacer array that may be used in a packed bed. FIG. 9 is a schematic side view diagram illustrating the spacer 200. FIG. 10 is a schematic top view diagram illustrating the spacer 200. The spacer 200 may be similar to the spacer 100 unless otherwise noted herein. For example, the spacer 200 includes a main body 202, a leading pin 204, and a trailing pin 206 as described above with respect to the spacer 100. Additionally, the spacer 200 includes at least one connector 208. The connector(s) 208 may be integral with the main body 202, and may extend from the main body 202 in an axial direction, or perpendicular to the longitudinal axis x, or may extend from the main body 202 in a direction transverse to the longitudinal axis x. As illustrated in FIG. 10, the connector(s) 208 may extend from the main body 202 in various directions, and may advantageously be used to connect, or couple, the spacer 200 to another object (e.g., another identical spacer 200 with its own connector(s) 208). Thus, the connector(s) may be used to connect a plurality of spacers 200 to one another.

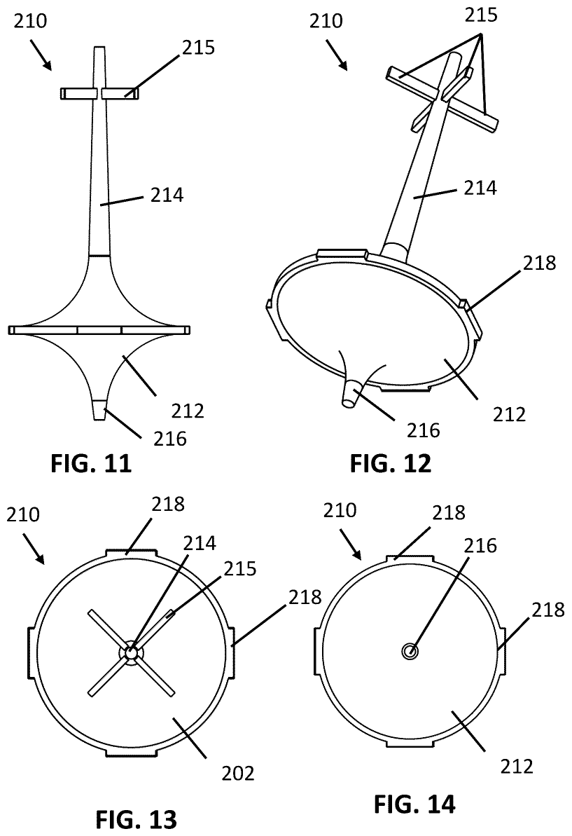

FIGS. 11-14 illustrate another embodiment of a connected spacer 210. The spacer 210 may be similar to the spacers 100, 200 unless otherwise noted herein. For example, the spacer 210 includes a main body 212, a leading pin 214, and a trailing pin 216 as described above with respect to the spacers 100, 200. Additionally, the spacer 210 includes at least one connector 218 as described above with respect to connector(s) 208. Additionally, the spacer 210 includes at least one connector 215. The connector(s) 215 may be integral with the main body 212, and may extend from the main body 212 in an axial direction, or perpendicular to the longitudinal axis x, or may extend from the main body 212 in a direction transverse to the longitudinal axis x. As illustrated in FIGS. 11-12, the connector(s) 215 may extend from the main body 212 in various directions, and may advantageously be used to connect, or couple, the spacer 210 to another object (e.g., another identical spacer 210 with its own connector(s) 215). Thus, the connector(s) may be used to connect a plurality of spacers 210 to one another.

FIGS. 11-12 illustrate the spacer 210, including the main body 212, the leading pin 214, the trailing pin 216, the connector(s) 218, and the connector(s) 215 as described herein. FIG. 13 illustrates a top-down view of the spacer 210, and thus only the leading pin 214, the main body 212, and the connector(s) 215, 218 are visible. FIG. 14 illustrates a bottom-up view of the spacer 210, and thus only the trailing pin 216, the main body 212, and the connector(s) 218 are visible.

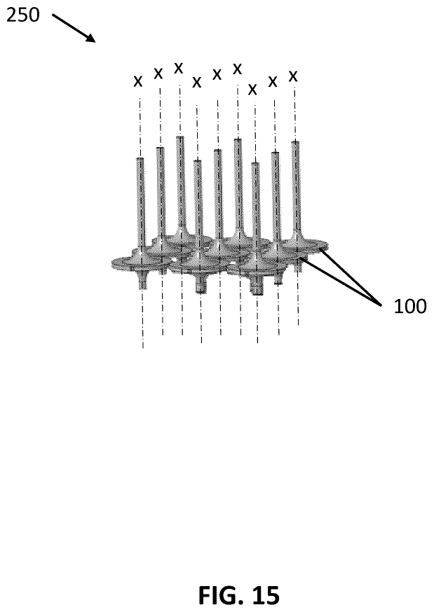

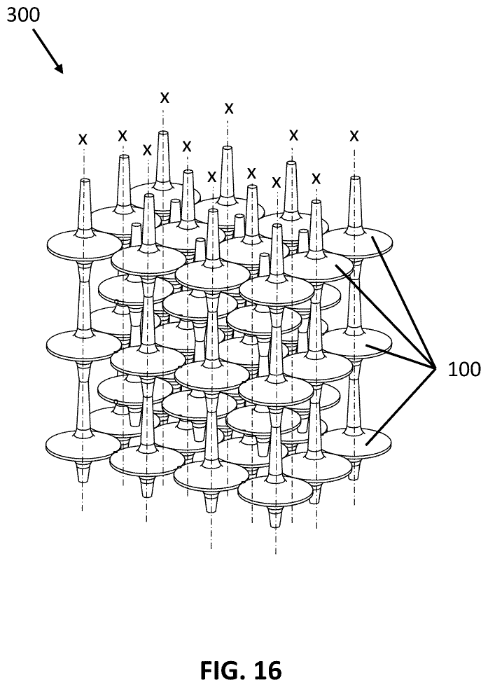

Adjacent spacers 200 may be connected to one another via the connector(s) 208 to form a spacer array. A plurality of spacers 200 may be connected in a plane (e.g., transverse plane 302), forming a grid 250 as illustrated in FIG. 15. Multiple grids 250 of spacers 200 may be arranged in a stack, forming the spacer array 300 as further discussed below in regard to FIGS. 16-19. As illustrated in FIG. 15, the grid 250 includes a plurality of spacers 100. In alternative embodiments, the grid 250 may include a plurality of connected spacers 200, or a combination of spacers 100, 200.

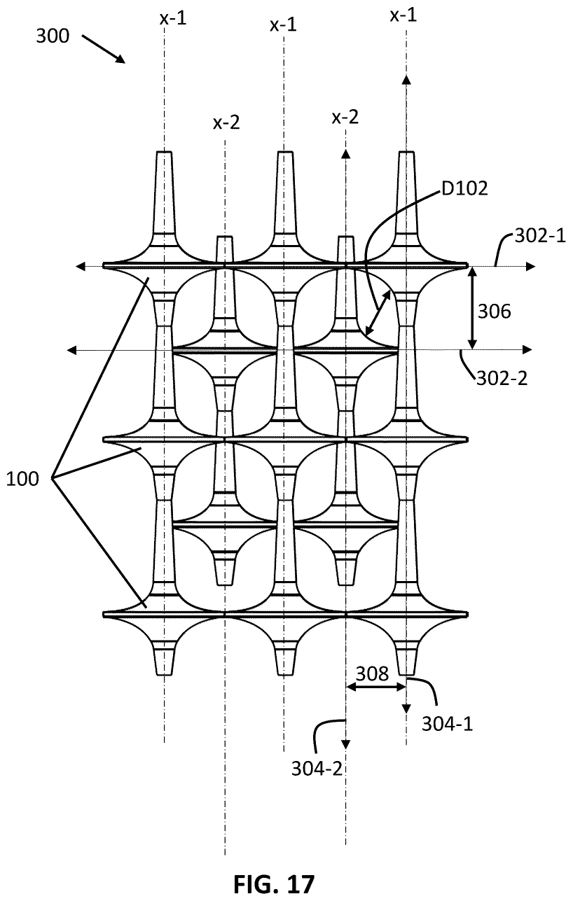

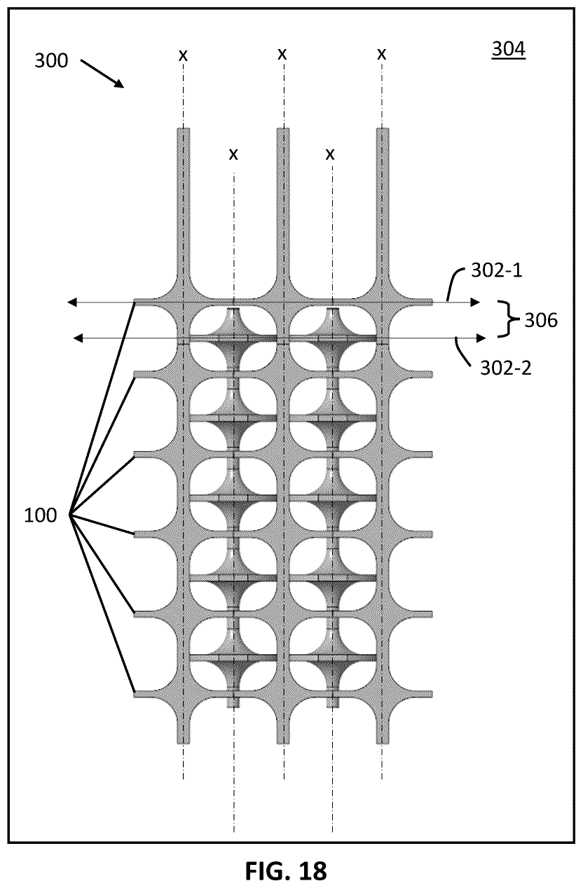

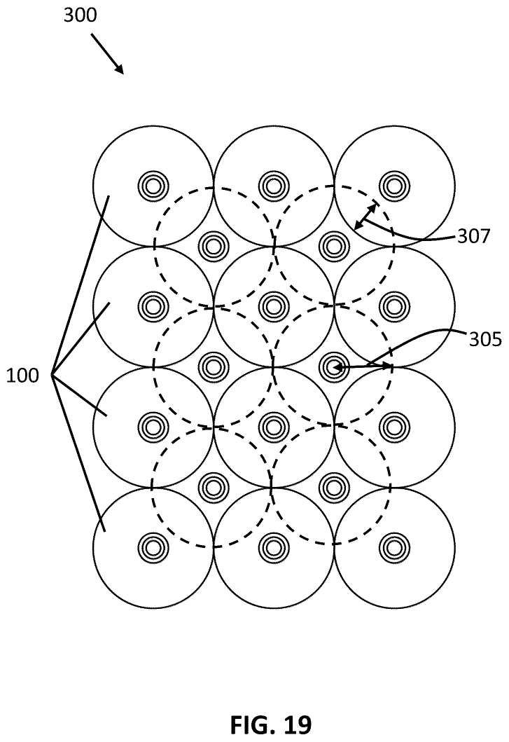

FIGS. 16-19 illustrate an example of a spacer array 300. FIG. 16 is a perspective view of the spacer array 300. FIG. 17 is a side view of the spacer array 300. FIG. 18 is a cross-sectional view of the spacer array 300. FIG. 19 is a top view of the spacer array 300. Multiple grids may be stacked to form the spacer array 300. As illustrated, the plurality of spacers 100 may advantageously form a tortuous flow path through the spacer array 300. A tortuous flow path may advantageously allow fluid flow through the spacer array 300 to have a turbulent flow that contacts a larger surface area of packing material within the packed bed than embodiments with less turbulent fluid flow, or that contacts a larger surface area of each of the plurality of spacers 100 than embodiments with less turbulent fluid flow. Increased contact between the fluid and the packing material results in more efficient filtering of the fluid. Increased contact between the fluid and the packing material results in more efficient catalytic transformation of one or more compounds in the fluid.

The plurality of spacers 100, 200, as illustrated, are arranged in at least one transverse plane 302 (FIGS. 17-18, e.g., 302-1, 302-2). Each of the at least one transverse planes 302 may be perpendicular relative to the longitudinal axes, x, of the spacers 100, 200 in that same transverse plane 302. The spacer array 300 may include 100 or fewer transverse planes 302, or may include 50 or fewer, 25 or fewer, 10 or fewer, 5 or fewer transverse planes 302, etc. Each transverse plane 302 may include a plurality of spacers 100, 200. Each of the plurality of spacers 100, 200 may be operably coupled to at least one other of the plurality of spacers 100, 200 (e.g., via the connector(s) 208 as described herein). Each of the longitudinal axes x of the plurality of spacers 100 may be parallel to one another in the transverse plane 302. Parallel longitudinal axis x may advantageously minimize resistance to fluid flow through the spacer array 300. As illustrated in FIGS. 16-19, the plurality of spacers may form a grid disposed in the at least one transverse plane 302.

As illustrated in FIGS. 17-18, the plurality of spacers 100 may be arranged in a plurality of transverse planes 302 (e.g., 302-1, 302-2). Each of the plurality of transverse planes 302 may be perpendicular relative to the longitudinal axes x of the spacers 100 in that same transverse plane 302, as described above. Each of the plurality of transverse planes 302 may be parallel to one another. Further, any two adjacent transverse planes 302 may have a plane space 306 therebetween, as measured in a direction parallel to the longitudinal axes x (FIG. 17). The plane space 306 may advantageously reduce restriction or resistance to fluid flow through the spacer array 300. The plane space 306 between adjacent transverse planes 302 may be 0.5 cm or greater, 0.75 cm or greater, 1.0 cm or greater, 1.25 cm or greater, or 1.5 cm or greater. The plane space 306 may be 6.0 cm or less, 5.0 cm or less, 4.5 cm or less, 4.0 cm or less, 3.5 cm or less, or 3.0 cm or less.

Additionally, any two main bodies 102 in adjacent transverse planes 302 may have a layer gap D102 therebetween, as measured in any direction (FIG. 17). The layer gap D102 may be a gap between the main bodies 102 of the spacers 100 in adjacent transverse planes 302 such that the main bodies 102 in adjacent transverse planes 302 are not in contact with one another. The layer gap D102 may advantageously reduce restriction or resistance to fluid flow through the spacer array 300. The layer gap D102 between main bodies 102 in adjacent transverse planes 302 may be 0.5 cm or greater, 0.75 cm or greater, 1.0 cm or greater, 1.25 cm or greater, or 1.5 cm or greater. The layer gap D102 may be 6.0 cm or less, 5.0 cm or less, 4.5 cm or less, 4.0 cm or less, 3.5 cm or less, or 3.0 cm or less.

In some alternative embodiments, each of the plurality of transverse planes 302 may not be parallel to one another and may instead be offset from one another at an angle. In such alternative embodiments, the plane space 306 may be variable along the transverse planes 302. Such alternative embodiments may provide an advantageous fluid flow (e.g., turbulent fluid flow) through the packed bed as desired.

The plurality of spacers 100 may further be arranged in at least one longitudinal plane 304 (FIGS. 17-18, e.g., 304-1, 304-2). Each of the at least one longitudinal planes 304 may be parallel to the longitudinal axes, x, of the spacers 100 in that same longitudinal plane 304. FIG. 17 illustrates a cross-sectional view of the spacer array 300 taken along a longitudinal plane 304. Further, any two adjacent longitudinal planes 304 may have a longitudinal plane space 308 therebetween, as measured in a direction perpendicular to the longitudinal axes x (FIG. 17). The longitudinal plane space 308 may be a gap between the axes x of the spacers 100 in adjacent longitudinal planes 304 such that the axes x in adjacent longitudinal planes 304 are not in contact with one another. The longitudinal plane space 308 may advantageously reduce restriction or resistance to fluid flow through the spacer array 300. The longitudinal plane space 308 may be 0.5 cm or greater, 0.75 cm or greater, 1.0 cm or greater, 1.25 cm or greater, 1.5 cm or greater. The longitudinal plane space 308 may be 6.0 cm or less, 5.0 cm or less, 4.5 cm or less, 4.0 cm or less, 3.5 cm or less, 3.0 cm or less, etc.

In some alternative embodiments, each of the plurality of longitudinal planes 304 may not be parallel to one another and may instead be offset from one another at an angle. In such alternative embodiments, the longitudinal plane space 308 may be variable along the longitudinal planes 304. Such alternative embodiments may provide an advantageous fluid flow (e.g., turbulent fluid flow) through the packed bed as desired.

Additionally, as illustrated in FIGS. 16-19, each of the main bodies 102 in one transverse plane 302 may partially overlap with at least one of the main bodies 102 in an adjacent transverse plane 302 when viewed in a direction parallel to the longitudinal axis x. Such partial overlap of the main bodies may advantageously increase the surface area of spacer(s) 100 upon which fluid may impinge or contact, increasing filtration efficiency and efficacy. Such partial overlap of the main bodies may further advantageously increase the surface area of spacer(s) 100 upon which fluid may impinge or contact, increasing catalytic efficiency and efficacy. Such partial overlap 307 (FIG. 19) may be 50% or less of the main body cross-sectional dimension W102 in one transverse plane 302, or may be 25% or less, 20% or less, 15% or less, 10% or less, 5% or less. Such partial overlap may include more than or equal to 1%, 7%, 12%, 15%, 20%, 30%, 40%, 50% of the main body cross-sectional dimension W102 in one transverse plane 302.

Further, as illustrated in FIGS. 16-19, the spacers 100 in a first transverse plane 302-1 may define a first plurality of longitudinal axis x-1, and the spacers 100 in a second transverse plane 302-2 define a second plurality of longitudinal axis x-2. The first and second transverse planes 302-1, 302-2 may be adjacent to one another. The second plurality of longitudinal axes x-2 may be transversely offset from the first plurality of longitudinal axes x-2 by an axis offset distance 305 as measured in a direction perpendicular to the longitudinal axes (FIG. 19). The axis offset distance 305 may be about 0.5 cm, 1.0 cm, 2.0 cm, or 3.0 cm. A longitudinal axis x-1 located within a first longitudinal plane 304-1 may be transversely offset from a longitudinal axis x-2 located within a second longitudinal plane 304-2 by about 0.5 cm, 1.0 cm, 2.0 cm, or 3.0 cm.

### Packed Beds Using the Spacers/Spacer Arrays

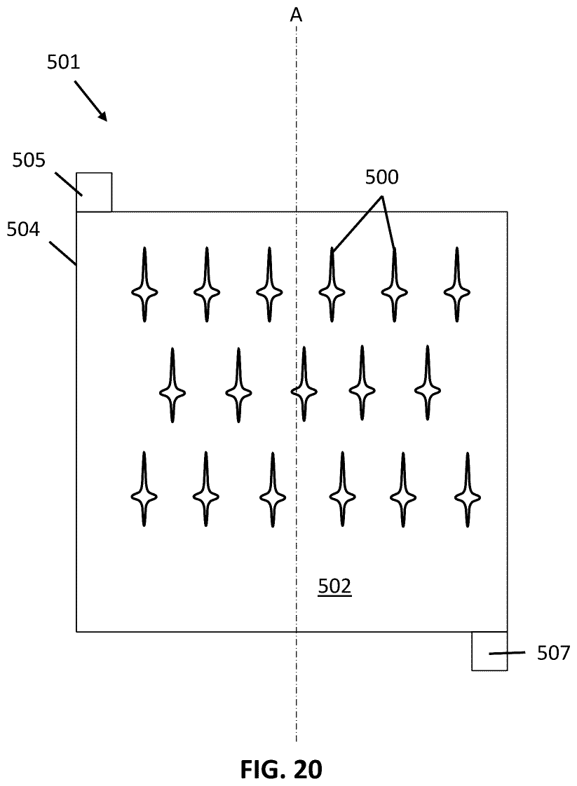

Packed beds may define any shape or structure and may be used for a variety of applications. For example, a packed bed may be a packed bed filter. Further, for example, a packed bed may be a packed bed reactor. In one specific example, the packed bed may be configured for use as gas filters. In another example, the packed bed may be configured for use as a gas or liquid reactor, or as a gas and liquid reactor. As diagrammatically illustrated in FIG. 20, a packed bed 501 may include at least one spacer 500 as described herein with respect to spacers 100, 200, 400, and with respect to spacer array 300 as described herein. The packed bed 501 may include a packing material 502 disposed between the plurality of spacers 500. The packing material 502 may be foam, as described further herein. The packing material 502 may include a catalyst, as described further herein. The packed bed 501 may include a housing 504. The plurality of spacers 100, 200, 400, 500 and packing material 402, 502 may be disposed within the housing 504. A spacer array constructed of the spacers 100, 200, 400, 500, and the packing material 502, may be disposed within the housing 504. The housing 504 may have an inlet 505 and an outlet 507. The inlet 505 defines an upstream end of the packed bed 501. The outlet 507 defines a downstream end of the packed bed 501. The plurality of spacers 100, 200, 400, 500 may be oriented within the housing such that the leading pins are oriented toward the upstream end and the trailing pins are oriented toward the downstream end. The housing may define a housing axis A. The longitudinal axes x of the plurality of spacers 100, 200, 400, 500 may be parallel with the housing axis A.

### Methods of Making a Spacer and Methods of Making a Spacer Array

The spacer(s) and spacer array(s) as described herein may be formed using a variety of methods, including injection molding, 3D printing, and machining. Various methods for forming spacers and spacer arrays are described below.

In one embodiment, each of the plurality of spacers may be 3D printed. Any suitable material for 3D printing may be used. For example, the spacers may be 3D printed using a plastic, polymer, ceramic, metal-organic framework (MOF), biomaterial, or metal material, or any combination thereof. Biomaterials may include collagen, pectin, gelatin, cellulose, and other solids derived from living systems. A MOF is a porous crystalline material made of metal ions or metal clusters interconnected by organic linkers. In one embodiment, each of the plurality of spacers may be injection molded using a plastic, metal, ceramic, metal-organic framework, biomaterial, or any combination thereof.

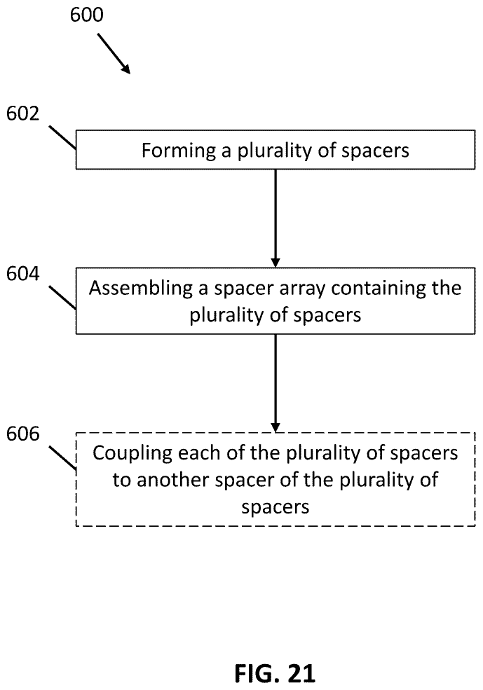

As illustrated in FIG. 21, a method 600 of making a spacer array (the spacer array as described herein) may include forming (e.g., molding or printing) a plurality of spacers 602 (the plurality of spacers are as described above). Molding the plurality of spacers may include injection molding the plurality of spacers individually. Molding the plurality of spacers may include injection molding the plurality of spacers integrally (e.g., as a single unit, or as multiple units). Printing the plurality of spacers may include 3D printing the plurality of spacers individually. Printing the plurality of spacers may include 3D printing the plurality of spacers integrally (e.g., as a single unit, or as multiple units). The method 600 may further include assembling the spacer array containing the plurality of spacers 604. As illustrated in dashed line, assembling the spacer array may optionally include coupling each of the plurality of spacers to another spacer of the plurality of spacers 606. Coupling each of the plurality of spacers to another spacer of the plurality of spacers may include coupling the main bodies of each of the spacers together. Coupling each of the plurality of spacers to another spacer of the plurality of spacers may include coupling the connectors (e.g., connector(s) 208 as described herein) of each of the spacers together.

### Methods of Using

The spacers described herein may be used as part of a packed bed, such as a packed bed filter or a packed bed reactor. The spacers may form a spacer array, which may be used as part of a packed bed. The packed bed may include a plurality of spacer (e.g., a spacer array) and one or more other packing materials, such as reticulated foam and optionally other filter materials, such as active particles, electrospun fine fibers, or any combination thereof.

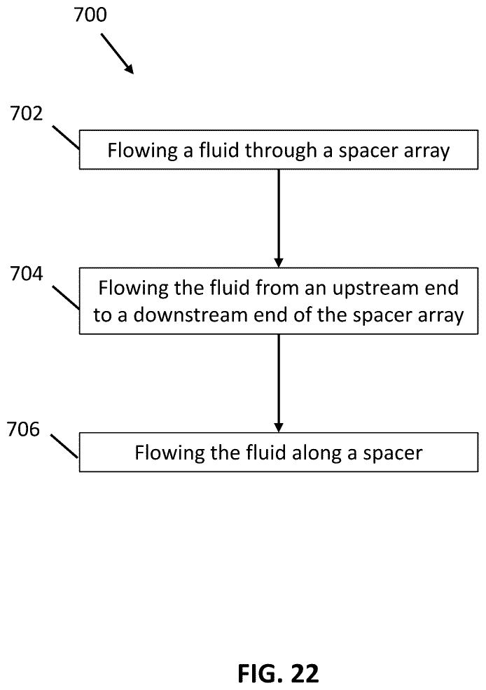

As illustrated in FIG. 22, a method 700 of using a packed bed may include flowing a fluid (i.e., a gas, liquid, or both) through a spacer array, such flowing indicated with reference number 702 (the spacer array as described herein). The fluid may be directed through the packed bed from an inlet to an outlet. The fluid may flow from an upstream end of the spacer array to a downstream end of the spacer array, such flow indicated with reference number 704. The fluid may flow along a spacer, such flowing indicated with reference number 706 (e.g., the fluid may flow along the leading pin to the main body, around the main body, and towards the downstream end). The fluid may flow through packing material (e.g., foam, such as reticulated foam, active particles, or a combination thereof). The fluid may be, for example, a gas, such as air, oxygen, nitrogen, hydrogen, or the like, or a liquid. Depending on the packing material used, impurities present in the fluid may be adsorbed or absorbed by, or may chemically react with, the packing material. The impurities may be selectively removed from the fluid or may be changed to a different chemical form.

### Spacer Materials

According to an embodiment, the spacer is made of a solid material. The spacer may be constructed of a metal, a plastic, a ceramic, carbon, metal-organic framework, biomaterial, or any combination thereof. In some embodiments, the spacer is constructed of and/or may be at least partially coated with an active material. An active material is a material that includes at least one component that is capable of participating in a chemical reaction and/or is capable of acting as a sorbent (absorbent and/or adsorbent). The physical and/or chemical functionality of the active material may vary based on the intended use of the spacer and/or packed bed containing the spacer. Examples of active materials include, but are not limited to, catalysts, adsorbents, absorbents, growth seeds, metal-organic frameworks, and any combination thereof. In some embodiments where the spacer is constructed of and/or is at least partially coated with an active material, the spacer may advantageously increase the filtration and or catalytic efficiency of the packed bed overall because the spacer itself participates in filtering and/or transforming one or more compounds of the fluid (e.g., air) that flows along and/or around the spacer.

A spacer may be constructed of and/or at least partially coated with a catalyst. Catalysts that are able to remove or prevent and/or reduce the emission of harmful gases into the atmosphere may be of particular interest. For example, the spacer may include a catalyst that is capable of breaking down ozone, that is, the catalyst is able to convert ozone to oxygen (O₂) by way of bond rearrangement. Examples of catalysts capable of destroying ozone include manganese oxide, copper oxide, cerium dioxide, or any combination thereof. Catalysts capable of transformations resulting in intermediates and/or final products that can be consumed and/or safely disposed of may also be of interest. For examples, catalysts capable of catalyzing cross-coupling reactions, hydrocarbon cracking reactions, paraffin synthesis, hydrogenation, dehydrogenation, carbon dioxide capture and conversion, C—H bond activation, Examples of catalysts include metal oxides, metals, group I metal salts, and group II metal salts. Catalysts can be grafted onto supports and/or impregnated within supports. Examples of supports that catalysts can be grafted onto and/or impregnated within include, alumina, carbon, zeolite, metal-organic frameworks, silica, and any combination thereof.

A spacer may be constructed of and/or at least partially coated with an adsorbent and/or absorbent capable of absorbing and/or absorbing a basic fluid, an acidic fluid, an organic compound, an inorganic compound, or combinations thereof. The fluid or compound may be a gas or a liquid. An adsorbent is a material capable of adsorbing a chemical; that is, the material is capable of isolating a chemical on at least a portion of its surface area. An adsorbent may be a chemisorbant, a physisorbent, or a chemisorbant-physisorbent hybrid. A physisorbent is an adsorbent that isolates a chemical through the formation of weak interactions (e.g., van der Waals and/or electrostatic forces) between the physisorbent and the chemical being adsorbed. A chemisorbent is an adsorbent that isolates a chemical through the formation of an ionic or covalent bond between the chemisorbent and the chemical being adsorbed. A chemisorbant-physisorbent hybrid is a chemisorbent grafted on and/or impregnant within a physisorbent. The identity of the adsorbent depends on the intended use of the composition. Adsorbents may be included that are capable of adsorbing a basic gas, an acidic gas, a gaseous organic compound, a gaseous inorganic compound, or combinations thereof.

In some embodiments, the adsorbent or absorbent is capable of adsorbing or absorbing a gas. Adsorbents and/or absorbents that are able to remove or prevent and/or reduce the emission of harmful gasses into the atmosphere may be of particular interest. For example, a spacer may be constructed of and/or at least partially coated with an adsorbent and/or absorbent capable of adsorbing and/or adsorbing carbon dioxide; carbon monoxide; perfluorocarbons; volatile organic compounds; sulfur oxides; nitrogen oxides; hydrogen sulfide; ammonia (basic fluid); or any combination thereof. Examples of active materials that include adsorbent and/or absorbent capable of adsorbing and/or absorbing a basic fluid, an acidic fluid, an organic compound, an inorganic compound, or combinations thereof include carbon such as activated carbon, zeolites (e.g., zeolite X, zeolite A, zeolite Y, zeolite β, and zeolite ZSM-5); silicates; metal-organic frameworks; covalent-organic frameworks; porous organic cages; graphite; mesoporous transition metal oxides; group I metal (Li, Na, K, Rb, Cs, Fr) carbonates; group I (Li, Na, K, Rb, Cs, Fr) metal hydroxide; group II metal (Be, Mg, Ca, Sr, Ba, Ra) hydroxide; group II metal (Be, Mg, Ca, Sr, Ba, Ra) oxide; nitrogen containing compounds such as amines, iminies, and/or ammonia; chemisorbents that have a carboxylic acid (COOH) functional group such as citric acid, terephthalic acid, trimesic acid, tartaric acid, maleic acid, benzoic acid, oxalic acid, and combinations thereof; chemisorbents that have been modified or impregnated by strong- or weak-acids such as hydrogen fluoride, hydrogen chloride, hydrogen bromide, sulfuric acid, phosphoric acid, nitric acid, perchloric acid, periodic acid, and any combination thereof; and any combination thereof.

### Packing Materials

One or more spacers may be included in a packing material (for example, see packing material 502 of FIG. 20). Such a packed bed includes one or more spacers and one or more packing materials. Within the packed bed, the packing material may or may not physically contact one or more spacers. A packed bed may include two or more layers, each layer including a packing material. The packing material of different layers may be the same or different.

The packing material may be any suitable packing material for a given application. Examples of packing materials include, but are not limited to, nonwoven materials, woven materials, porous substrates, tapes, mesh, and the like. The packing material may be constructed of and/or at least partially coated with a polymer, a ceramic, a metal, an alloy, glass, a natural fiber, wet-laid material, electrospun fiber, or the like, or any combination thereof.

The packing material may be a porous substrate such as a foam. The foam may be a reticulated foam. The term reticulated foam is typically used to refer to open-cell foams that form a net or a mesh shape (as opposed to closed-cell foams that form bubble or cell shapes). Reticulated foams typically are very porous and have a low density. For example, reticulated foams may have a porosity of 60% or greater, 90% or greater or 95% or greater. Examples of reticulated foams include reticulated polyester, reticulated polyether, reticulated polyurethane, reticulated polyurethane without heat treatment, reticulated cellulose, reticulated melamine, reticulated activated carbon, reticulated vitreous carbon, reticulated silicone carbide, reticulated metal oxides, reticulated alumina, reticulated graphene, reticulated reduced metals, and any combination thereof. The reticulated foam may have any suitable number of pores per inch (PPI). For example, the reticulated foam may have 3 PPI or greater, 10 PPI or greater, 20 PPI or greater, 30 PPI or greater, 40 PPI or greater, 50 PPI or greater, 60 PPI or greater, 70 PPI or greater, 80 PPI or greater, 90 PPI or greater or 100 PPI or less, 90 PPI or less, 80 PPI or less, 70 PPI or less, 60 PPI or less, 50 PPI or less, 40 PPI or less, 30 PPI or less, 20 PPI or less, or 10 PPI or less.

A packing material may include a plurality of active particles. The plurality of active particles may be coated onto the filter material, embedded within the filter material, or both. An active particle includes an active material. The active material of the plurality of active particles may be any active material described herein. In some embodiments, a packed bed includes one or more spacers that are constructed of and/or at least partially coated with an active material and a packing material that includes a plurality of active particles. In some such embodiment, the active materials are the same. In other such embodiment, the active materials are different.

### EXAMPLES

The spacers may be configured in any suitable way and may include different spacer geometries, different spacer array geometries, one or multiple transverse planes, one or multiple longitudinal planes, etc. While many possible configurations and shapes may be used, the goal of lower resistance or restriction to fluid flow while also increasing flow rate and maintaining filter efficiency remains unchanged. Thus, the variables described herein may be modified, in order to reach the stated goal, and such modifications are considered to be described herein.

Various aspects of the spacers and their arrangement in an array or filter were simulated to study the effects of shape, size, and relative position of spacers.

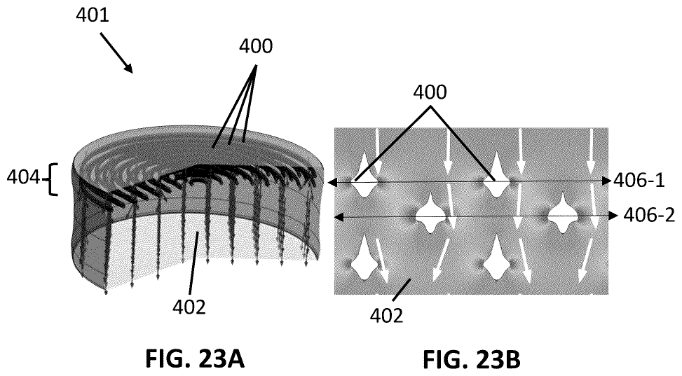

FIGS. 23A and 23B illustrate an example filter 401 and fluid velocity therethrough, which may include a filter material 402 and at least one spacer 400 making up a spacer array 404. Certain aspects of the spacers 400 and spacer array 404 may be similar to those discussed above with regard to spacers 100, 200 and spacer array 300. However, as illustrated in FIG. 23A, each of the plurality of spacers 400 may form a ring disposed in the at least one transverse plane 406 (e.g., 406-1, 406-2 as illustrated in FIG. 23B, the at least one transverse plane also as described herein using reference 302). In other words, the main body, the leading pin, and the trailing pin each form a ring. In some embodiments, the plurality of spacers 400 may each be disposed in the at least one transverse plane 406. In some embodiments, the plurality of spacers 400 may form concentric rings. The plurality of concentric rings may form a single layer in one transverse plane 406. Multiple layers, each formed by a plurality of concentric rings in different transverse planes 406, may be arranged in a stack. FIG. 23B illustrates the cross-sectional spacer shapes of various spacers 400.

FIG. 23A illustrates uniform flow with very little fluid flow fluctuation relative to horizontal position, if any. FIG. 23B illustrates the same in an enlarged view. Additionally, the darker zones located at the axial ends of each cross-sectional spacer shape indicate higher velocity of fluid in those zones. Higher velocity is normally associated with less efficient filtration, as the fluid spends less time in contact with any filter material. In this case if the spacers themselves are constructed using filter material in addition to the present filter material, for example, a higher velocity may not be associated with less efficient filtration since the fluid will contact filter material even at a higher velocity.

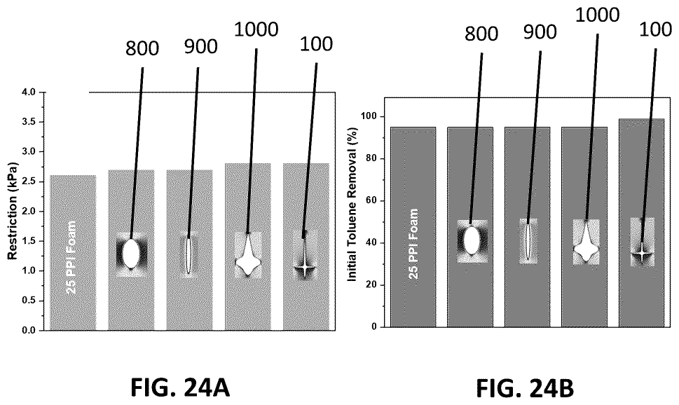

Various simulated cross-sectional spacer shapes are illustrated in FIG. 24A. The restriction of fluid flow (in kilopascals, kPa) resulting from the different spacer shapes is shown in the y-axis. All other simulation conditions remained constant for each different spacer shape (volumetric flowrate, air viscosity, air density, spacer height, foam porosity, number of spacer rows, spacer orientation, distance between spacers, filter pack diameter, inlet contaminant concentration, etc.). At the far left, a filter only including foam (25 pore per inch, PPI) without any spacers results in the lowest restriction. Moving from left to right, each consecutive cross-sectional spacer shape (e.g., ovular spacer 800, thin ovular spacer 900, bulging spacer 1000, and spacer 100) results in a higher restriction. Higher restriction is less desirable but may be offset by increasing the amount of surface area that fluid flow may contact within the foam and/or spacer, which increases filtration efficiency. FIG. 24B illustrates simulated initial toluene (an example contaminant) removal from air, and the same cross-sectional spacer shapes are shown in the x-axis of FIG. 24B. As illustrated, the spacer 100 results in the most efficient contaminant removal.

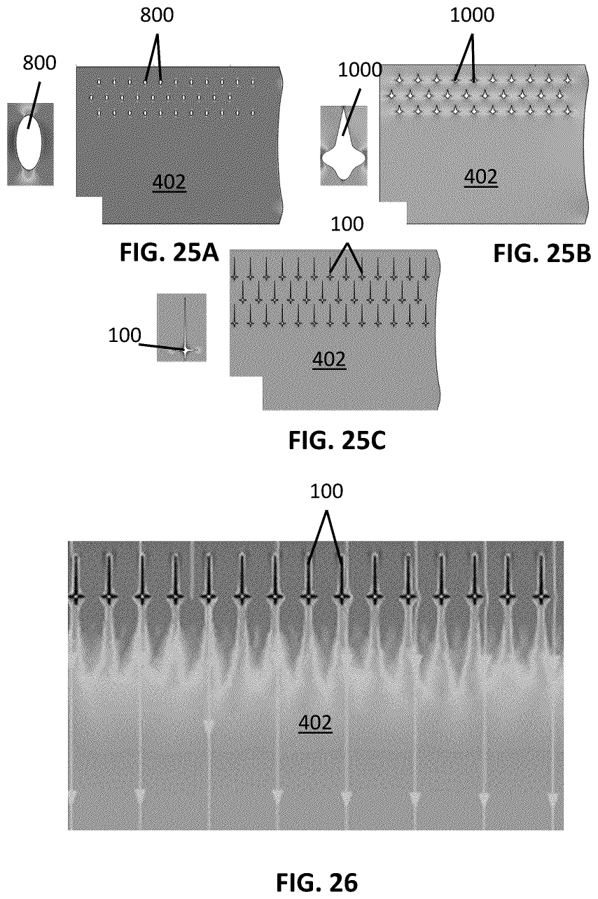

FIGS. 25A, 25B, and 25C illustrate simulated velocity fields of different cross-sectional spacer shapes. The simulations each contained three rows of spacers. It is understood that more or fewer rows could be used to optimize a filtration application, depending on a user's needs. FIG. 25A illustrates the ovular spacer 800 dispersed in the filter material 402. The velocity at the spacer face is about 8 meters per second. FIG. 25B illustrates the bulging spacer 900 dispersed in the filter material 402. The velocity at the spacer face is about 4 meters per second (m/s). FIG. 25C illustrates the spacer 100 as described herein (e.g., lentil-shaped with leading and trailing pins) dispersed in the filter material 402, and the velocity at the spacer face is about 2 m/s. Thus, the spacer 100 as described herein results in a lower velocity of fluid flow around the spacer. Lower velocity of fluid flow around the spacer lengthens the time the fluid is dispersed within the filter material 402 and along the spacer 100, likely resulting in more efficient filtration. Simultaneously, this increased efficiency only resulted in slightly higher restriction (kPa, FIG. 24A). The lentil-and-pin spacer shape thus was found to effectively mitigate about 60% of the residual contaminants which would have bypassed the ovular/other spacers or spacer-free foam.

FIG. 26 illustrates a simulated concentration profile of toluene (in moles of toluene per cubic meter of the adsorbent spacer-coated foam material) through a single layer of lentil-and-pin adsorbent spacers suspended in adsorbent-coated foam (a filter material). The darker areas indicate the presence of higher concentrations of toluene, and lighter areas indicate where zero toluene concentration is observed. Compared to a filter bed without any spacers, the filter bed with spacers simulated a faster filtration of toluene than the simulated filter bed without spacers (e.g., the toluene was simulated to be removed at a shallower depth when spacers were present, by about 0.5 cm shallower when all other variables were held constant). Further, the darker areas immediately below the spacers 100 indicates that there is a simulated flow throttle that occurs in between spacers 100. Such a flow throttle may advantageously convene contaminate particles for filtration of the same. In applications with dilute feedstocks (e.g., air filtration), having contaminant levels around 10-100 parts per billion, such a throttle may advantageously increase filtration efficiency as the dilute feedstock is convened.

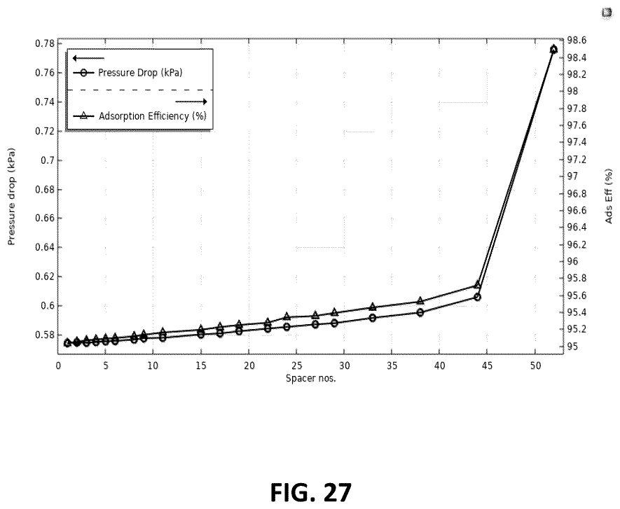

FIG. 27 illustrates simulated pressure drop and simulated adsorption efficiency on opposing y-axes, with number of spacers on the x-axis. As the number of spacers increases, so does pressure drop (e.g., resistance) and adsorption efficiency. However, increasing the number of spacers enhances the adsorption efficiency at a faster rate than the simulated pressure drop. For less efficient spacer designs (e.g., ovular spacers 800, bulging spacers 1000), the adsorption efficiency may not increase at a faster rate than the simulated pressure drop as spacer number increases.

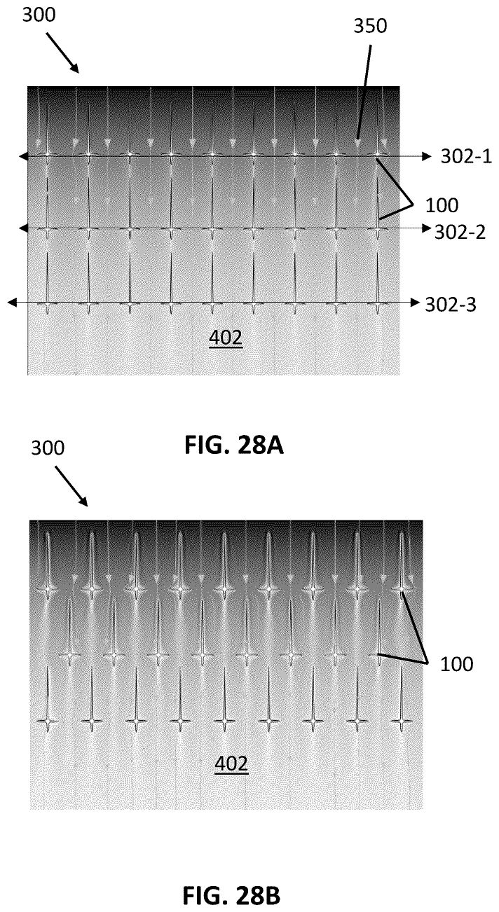

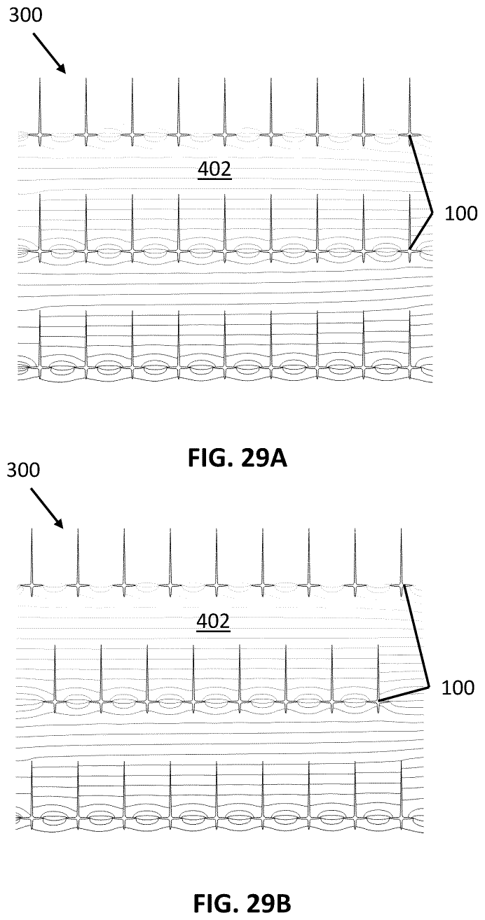

FIGS. 28A and 28B illustrate simulated concentration profiles using the lentil-and-pin spacers 100 as described herein. FIGS. 28A and 28B illustrate a spacer array 300 as described herein (unless otherwise noted), with three rows of spacers 100. Each row of spacers 100 is located in a separate transverse plane 302 (e.g., 302-1, 302-2, 302-3). The simulation included an approximately 10 cm long packed filter bed (as measured vertically in FIGS. 28A and 28B), and fluid flow was in a downstream direction indicated by the transparent arrows 350. All other simulation conditions remained constant as described with respect to FIGS. 24A and 24B (volumetric flowrate, air viscosity, air density, spacer height, foam porosity, number of spacer rows, spacer orientation, distance between spacers, filter pack diameter, inlet contaminant concentration, etc.). FIG. 28A illustrates a spacer array 300 with in-line spacer axes. That is, the spacers 100 are stacked so that a downstream spacer 100 is directly below an upstream spacer 100 along the same longitudinal axis. FIG. 28B illustrates offset spacer axes. As described above, and as illustrated in FIG. 28B, such offset/partial overlap may include up to 50% of the main body cross-sectional dimension in one transverse plane. As shown in FIG. 28A, about 20% of the contaminant level may remain at the end of the 10 cm long bed, whereas the contaminant may be removed within 7 cm of the length of the bed as shown in FIG. 28B. FIGS. 29A and 29B illustrate simulated pressure fields throughout the bed of FIGS. 28A and 28B, respectively. FIGS. 29A and 29B illustrate mixing zones around the edges of the spacers 400, and pressure losses were about constant in either configuration. Constant pressure loss indicates a more efficient spacer shape.

### Illustrative Embodiments

The technology described herein is defined in the claims. However, below is provided a non-exhaustive listing of non-limiting embodiments. Any one or more of the features of these embodiments may be combined with any one or more features of another example, embodiment, or aspect described herein.

1. Embodiment 1: A spacer array comprising a plurality of spacers,
each spacer defining a longitudinal axis and comprising:
   a main body having a main body cross-sectional dimension;
   a leading pin extending from the main body and upstream of the main body, the leading pin having a leading pin cross-sectional dimension; and
   a trailing pin extending from the main body and downstream of the main body, the trailing pin having a trailing pin cross-sectional dimension,
   the main body cross-sectional dimension being greater than the leading pin cross-sectional dimension and the trailing pin cross-sectional dimension.
      2. Embodiment 2: The spacer array of embodiment 1, wherein the plurality of spacers are arranged in at least one transverse plane, and wherein the at least one transverse plane is transverse relative to the longitudinal axes of the spacers in the transverse plane.
      3. Embodiment 3: The spacer array of any one of embodiments 1 or 2, wherein the plurality of spacers are arranged in at least one longitudinal plane, and wherein the at least one longitudinal plane is parallel to the longitudinal axes of the spacers in the longitudinal plane.
      4. Embodiment 4: The spacer array of any one of embodiments 1 to 3, wherein the spacer array comprises 100 or fewer transverse planes, each transverse plane comprising a plurality of spacers.
      5. Embodiment 5: The spacer array of any one of embodiments 1 to 4, wherein each of the plurality of spacers is operably coupled to at least one other of the plurality of spacers.
      6. Embodiment 6: The spacer array of any one of embodiments 1 to 5, wherein a fluid is configured to flow in a downstream direction along the plurality of spacers.
      7. Embodiment 7: The spacer array of any one of embodiments 1 to 6, wherein the leading pin and the trailing pin extend along the longitudinal axis.
      8. Embodiment 8: The spacer array of any one of embodiments 1 to 7, wherein the main body cross-sectional dimension, the leading pin cross-sectional dimension, and the trailing pin cross-sectional dimension are each measured perpendicular to the longitudinal axis.
      9. Embodiment 9: The spacer array of any one of embodiments 1 to 8, wherein each of the longitudinal axes of the plurality of spacers are parallel to one another.
      10. Embodiment 10: The spacer array of any one of embodiments 1 to 9, wherein the main body is substantially lentil-shaped.
      11. Embodiment 11: The spacer array of any one of embodiments 1 to 10, wherein an outer surface of each of the plurality of spacers comprises a curved surface.
      12. Embodiment 12: The spacer array of any one of embodiments 1 to 11, wherein an outer surface of each of the plurality of spacers is free of edges and vertices.
      13. Embodiment 13: The spacer array of any one of embodiments 1 to 12, wherein each of the plurality of spacers comprises at least one of an adsorbent and a catalyst.
      14. Embodiment 14: The spacer array of any one of embodiments 1 to 13, wherein each of the plurality of spacers is 3D printed.
      15. Embodiment 15: The spacer array of any one of embodiments 1 to 13, wherein each of the plurality of spacers is injection molded.
      16. Embodiment 16: The spacer array of any one of embodiments 1 to 15, wherein each of the plurality of spacers has a length measured along the longitudinal axis, and wherein the length is 2.5 cm or less, 2.0 cm or less, 1.5 cm or less, 1.25 cm or less, or 1 cm or less.
      17. Embodiment 17: The spacer array of any one of embodiments 1 to 16, wherein each of the leading pins has a length and each of the trailing pins has a length, and wherein the length of the leading pins is greater than the length of the trailing pins.
      18. Embodiment 18: The spacer array of any one of embodiments 1 to 17, wherein each of the leading pins has a length and each of the trailing pins has a length, and wherein a ratio of the length of the leading pins to the length of the trailing pins is greater than or equal to 1.25:1.00.
      19. Embodiment 19: The spacer array of any one of embodiments 1 to 18, wherein the plurality of spacers are arranged in a plurality of transverse planes, wherein each of the plurality of transverse planes is transverse relative to the longitudinal axes of the spacers in the transverse plane, and wherein any two adjacent transverse planes have a layer gap therebetween.
      20. Embodiment 20: The spacer array of embodiment 19, wherein the layer gap is 0.5 cm or greater, 0.75 cm or greater, 1.0 cm or greater, 1.25 cm or greater, or 1.5 cm or greater, and 6 cm or less, 5 cm or less, 4.5 cm or less, 4 cm or less, 3.5 cm or less, or 3 cm or less.
      21. Embodiment 21: The spacer array of any one of embodiments 1 to 20, wherein each of the main body cross-sectional dimensions in one transverse plane partially overlaps with at least one of the main body cross-sectional dimensions in an adjacent transverse plane when viewed in a direction parallel to the longitudinal axis, and wherein such partial overlap includes less than or equal to 50% of the main body cross-sectional dimension in one transverse plane.
      22. Embodiment 22: The spacer array of any one of embodiments 1 to 21, wherein the spacers in a first transverse plane define a first plurality of longitudinal axis and the spacers in a second transverse plane define a second plurality of longitudinal axis, and wherein the second plurality of longitudinal axis are transversely offset from the first plurality of longitudinal axis.
      23. Embodiment 21: The spacer array of any one of embodiments 1 to 22, wherein the plurality of spacers define a tortuous flow path through the array.
      24. Embodiment 24: The spacer array of any one of embodiments 1 to 23, wherein the plurality of spacers form a ring disposed in a transverse plane.
      25. Embodiment 25: The spacer array of any one of embodiments 1 to 23, wherein the plurality of spacers form a plurality of concentric rings disposed in the transverse plane.
      26. Embodiment 26: The spacer array of any one of embodiments 1 to 23, wherein the plurality of spacers form a grid disposed in a transverse plane.
      27. Embodiment 27: The spacer array of any one of embodiments 1 to 26, the spacer array further comprising at least one connector, wherein each of the plurality of spacers is operably coupled to at least one other of the plurality of spacers via the at least one connector.
      28. Embodiment 28: The spacer array of any one of embodiments 1 to 27, wherein the spacers in a transverse plane are coupled to each other via one or more connectors.
      29. Embodiment 29: A packed bed comprising:
a spacer array comprising a plurality of spacers, each spacer defining a longitudinal axis and comprising:
   a main body;
   a leading pin extending from the main body and upstream of the main body; and
   a trailing pin extending from the main body and downstream of the main body,
   the main body having a main body cross-sectional dimension greater than a leading pin cross-sectional dimension and a trailing pin cross-sectional dimension; and a packing material disposed between the plurality of spacers.
      30. Embodiment 30: A packed bed comprising the spacer array of any one of embodiments 1 to 28 and a packing material disposed between the plurality of spacers.
      31. Embodiment 31: The packed bed of embodiments 29 or 30, wherein the packed bed is a packed bed filter, a packed bed reactor, or both.
      32. Embodiment 32: The packed bed of any one of embodiments 29 to 31, wherein the packing material comprises reticulated foam.
      33. Embodiment 33: The packed bed of any one of embodiments 29 to 32, wherein the plurality of spacers comprises carbon.
      34. Embodiment 34: The packed bed of any one of embodiments 29 to 33, further comprising a housing, wherein the spacer array and the packing material are disposed within the housing.
      35. Embodiment 35: A method of making a spacer array, the method comprising:
molding or printing a plurality of spacers, each spacer defining a longitudinal axis and comprising:
   a main body;
   a leading pin extending from the main body and upstream of the main body; and
   a trailing pin extending from the main body and downstream of the main body,
   the main body having a main body cross-sectional dimension greater than a leading pin cross-sectional dimension and a trailing pin cross-sectional dimension; and assembling the spacer array containing the plurality of spacers.
      36. Embodiment 36: The method of embodiment 35, wherein molding the plurality of spacers comprises injection molding the plurality of spacers.
      37. Embodiment 37: The method of embodiments 35 or 36, wherein printing the plurality of spacers comprises 3D printing the plurality of spacers.
      38. Embodiment 38: The method of any one of embodiments 35 to 37, wherein assembling the spacer array comprises coupling each of the plurality of spacers to another spacer of the plurality of spacers.
      39. Embodiment 39: A method for filtering a fluid through a filter comprising:
flowing a fluid through the spacer array of any one of embodiments 1 to 28.
   40. Embodiment 40: The method of embodiment 39, wherein the fluid flows from an upstream end of the spacer array to a downstream end of the spacer array, and wherein when the fluid flows along a spacer the fluid flows along the leading pin to the main body, around the main body, and towards the downstream end.

The foregoing description of the example embodiments has been presented for the purposes of illustration and description. It is not intended to be exhaustive or to limit the embodiments to the precise form disclosed. Modifications and variations are possible in light of the above teaching. Any or all features of the disclosed embodiments can be applied individually or in any combination and are not meant to be limiting, but purely illustrative. It is to be understood that the above description is intended to be illustrative, and not restrictive, and the claims are not limited to the illustrative embodiments as set forth herein.

1. A spacer array comprising a plurality of spacers,
each spacer defining a longitudinal axis and comprising:
a main body having a main body cross-sectional dimension;
a leading pin extending from the main body and upstream of the main body, the leading pin having a leading pin cross-sectional dimension; and
a trailing pin extending from the main body and downstream of the main body, the trailing pin having a trailing pin cross-sectional dimension,
the main body cross-sectional dimension being greater than the leading pin cross-sectional dimension and the trailing pin cross-sectional dimension.

2. The spacer array of claim 1, wherein the plurality of spacers are arranged in at least one transverse plane, and wherein the at least one transverse plane is transverse relative to the longitudinal axes of the spacers in the transverse plane.

3. The spacer array of claim 1, wherein each of the plurality of spacers is operably coupled to at least one other of the plurality of spacers.

4. The spacer array of claim 1, wherein the leading pin and the trailing pin extend along the longitudinal axis.

5. The spacer array of claim 1, wherein the main body cross-sectional dimension, the leading pin cross-sectional dimension, and the trailing pin cross-sectional dimension are each measured perpendicular to the longitudinal axis.

6. The spacer array of claim 1, wherein each of the longitudinal axes of the plurality of spacers are parallel to one another.

7. The spacer array of claim 1, wherein the main body is substantially lentil-shaped.

8. The spacer array of claim 1, wherein an outer surface of each of the plurality of spacers comprises a curved surface.

9. The spacer array of claim 1, wherein an outer surface of each of the plurality of spacers is free of edges and vertices.

10. The spacer array of claim 1, wherein each of the plurality of spacers comprises at least one of an adsorbent and a catalyst.

11. The spacer array of claim 1, wherein each of the plurality of spacers has a length measured along the longitudinal axis, and wherein the length is 2.5 cm or less.

12. The spacer array of claim 1, wherein each of the leading pins has a length and each of the trailing pins has a length, and wherein the length of the leading pins is greater than the length of the trailing pins.

13. The spacer array of claim 1, wherein each of the leading pins has a length and each of the trailing pins has a length, and wherein a ratio of the length of the leading pins to the length of the trailing pins is greater than or equal to 1.25:1.00.

14. The spacer array of claim 1, wherein the plurality of spacers are arranged in a plurality of transverse planes, wherein each of the plurality of transverse planes is transverse relative to the longitudinal axes of the spacers in the transverse plane, and wherein any two adjacent transverse planes have a layer gap therebetween.

15. The spacer array of claim 1, wherein each of the main body cross-sectional dimensions in one transverse plane partially overlaps with at least one of the main body cross-sectional dimensions in an adjacent transverse plane when viewed in a direction parallel to the longitudinal axis, and wherein such partial overlap includes less than or equal to 50% of the main body cross-sectional dimension in one transverse plane.

16. The spacer array of claim 1, wherein the spacers in a first transverse plane define a first plurality of longitudinal axis and the spacers in a second transverse plane define a second plurality of longitudinal axis, and wherein the second plurality of longitudinal axis are transversely offset from the first plurality of longitudinal axis.

17. The spacer array of claim 1, the spacer array further comprising at least one connector, wherein each of the plurality of spacers is operably coupled to at least one other of the plurality of spacers via the at least one connector.

18. A packed bed comprising:
a spacer array comprising a plurality of spacers, each spacer defining a longitudinal axis and comprising:
a main body;
a leading pin extending from the main body and upstream of the main body; and
a trailing pin extending from the main body and downstream of the main body,
the main body having a main body cross-sectional dimension greater than a leading pin cross-sectional dimension and a trailing pin cross-sectional dimension; and
a packing material disposed between the plurality of spacers.

19. The packed bed of claim 18, wherein the packing material comprises reticulated foam.

20. The packed bed of claim 18, further comprising a housing, wherein the spacer array and the packing material are disposed within the housing.
